(19) United States
(12) Patent Application Publication
(10) Pub. No.: US 2003/0093486 A1
(43) Pub. Date: May 15, 2003

(54) CIM gateway for supervising and controlling telecommunications transport networks

(75) Inventors: Famory Toure, Massy (FR); Julien Robinson, Paris (FR)

Correspondence Address: SUGHRUE MION, PLLC, Suite 800, 2100 Pennsylvania Avenue, Washington, DC, 20037-3213, US

(73) Assignee: ALCATEL

(21) Appl. No.: 10/283,184

(22) Filed: Oct. 30, 2002

(30) Foreign Application Priority Data
Oct. 31, 2001 (FR) 01 14 170

(51) Int. Cl. G06F 15/16

(52) U.S. Cl. 709/208; 709/223

(57) ABSTRACT

A method of using a supervisor client to supervise and control a telecommunications transport network associated with at least one data server based on a CIM type protocol, the method consisting in connecting said supervisor client to at least one gateway having means for providing a connection between said server and said supervisor client by using a description of the data of said server on the basis of a management information base.

The invention relates to a system for supervising and controlling a telecommunications transport network.

### BACKGROUND OF THE INVENTION

FIG. 1 shows a supervision and control system of the prior art, together with a portion of the controlled transport network.

That transport network comprises a set of network elements R1, R2, R3, R4 which may be switches, links, etc.

It is associated with one or more data servers S1, S2. Communication between the transport network elements and the data servers generally takes place using a communication protocol known as common information model (CIM) or simple network management protocol (SNMP).

The data servers S1, S2 are also connected to one or more supervisor clients C1, C2 serving in particular to display data in graphical form, to record it, and to process it, etc.

Communication between those supervisor clients C1, C2 and the data servers usually complies with a protocol that is specific to the software implemented on the supervisor clients.

It should be observed that in certain prior art solutions, the supervisor client C2 may be directly connected to the network elements R4 that are to be supervised.

Numerous solutions exist for supervising the elements of a telecommunications network in accordance with the CIM protocol. Particular mention can be made of European patent application EP 1 061 445 filed by Sun Microsystems. Nevertheless, that solution consists in using a “CIM Workshop” supervisor application, itself compatible with the CIM protocol. Such an approach consequently suffers from being open since it does not enable the network management protocol used by the telecommunications network elements to be decoupled from the supervisor applications.

European patent application EP 1 103 881 discloses a gateway providing an interface between elements of a telecommunications network supporting CIM protocol and network supervisor applications supporting the common management information protocol (CMIP). Nevertheless, experience shows that those network supervisor applications are systems that are complex and difficult to implement, in particular on a data processing system (a computer) of modest size. Furthermore, those systems require lengthy training in order to achieve mastery and they do not always provide advanced data animation functions.

In a field other than that of supervising and controlling telecommunications networks, there also exist tools for supervising factories or automated processes. Those tools are generally based on the object linking and embedding for process control (OPC) standard, with that communications standard being commonly used on the TM Windows system from Microsoft.

Those “off-the-shelf” tools requiring little development are generally provided with multiple data animation functions (zoom, pan, network presentation as a plurality of layers, etc.). Ergonomically they are good, but they are not adapted to supervising a transport network as described in FIG. 1. In particular, they can neither supervise nor control network elements using the CIM protocol.

An example of one such tool is the “Graph WorX32” software from Iconics, which makes it possible in particular to monitor temperature sensors, inputs/outputs, potentiometers, voltage indicators, etc.

### OBJECT AND SUMMARY OF THE INVENTION

The object of the present invention is thus to be able to use such supervisor tools based on the standardized OPC protocol for supervising a transport network, in particular a telecommunications network, comprising a large number of network elements using the CIM standard.

To do this, the invention provides a method of using a supervisor client to supervise and control a telecommunications transport network associated with at least one data server based on a CIM type protocol. The method of the invention consists in connecting the supervisor client to at least one gateway having means for providing a connection between the server and the supervisor client by using a description of the data of the server on the basis of a management information base.

The supervisor client may be based on an OPC type protocol.

In a preferred implementation of the invention, the description can be implemented in the XML language.

The invention also provides a data server based on a CIM type protocol, the server including at least one gateway suitable for providing a connection with a supervisor client based on an OPC type protocol, using a description of the data of said data server on the basis of a management information base. This description may be implemented in the XML language.

### BRIEF DESCRIPTION OF THE DRAWINGS

The invention and its advantages appear more clearly from the following description given with reference to the accompanying figures.

FIG. 1, described above, is a diagram showing an existing system for supervising a transport network.

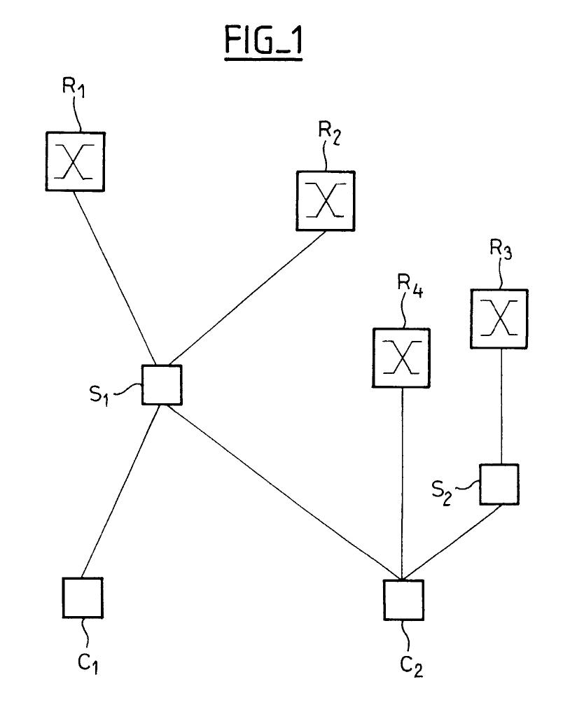

FIG. 2 is a diagram showing a system of the invention for supervising and controlling a transport network.

### MORE DETAILED DESCRIPTION

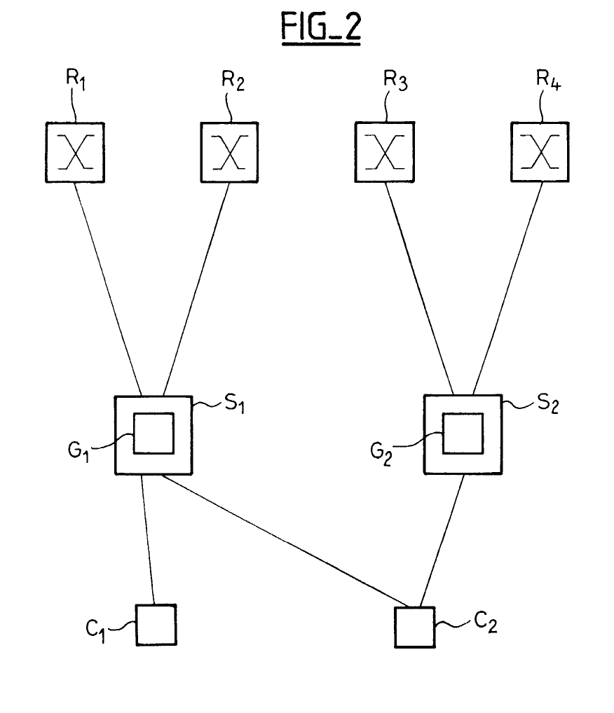

A system for supervising and controlling a telecommunications transport network is shown in FIG. 2. Consideration is given more particularly to its application to a telecommunications network.

The elements R1, R2, R3, R4 of the network to be supervised can comprise a router, a switch, etc. They send their data to data servers S1, S2.

The data servers communicate with supervisor clients C1, C2 of the OPC type. These communications are provided via one or more gateways G1, G2. These gateways may be integrated in the data servers S1, S2.

The gateways G1, G2 are programs defining a communications protocol between a CIM data server and an OPC supervisor client, enabling the data that is to be supervised to be displayed, preferably in the form of a tree structure, and enabling the data to be animated. The data supplied by the data servers S1, S2 comprises objects to be supervised and their properties. The term “object” is used to designate a network element belonging to the transport network in question.

A first step of describing data is defined. The description is made by scanning through and selecting the data to be supervised from the data in a management information base (MIB), while using the syntax of an object-oriented language such as XML (extended Markup Language) to define said data.

The description of an element (or class) of the management information base in the XML language is of the following form:

<CLASS NAME = “CIM_SwitchPort” ISA '2 “CIMCLASS”>
<ATTRIBUTES>
<CIMATTRIBUTE NAME = “Description” TYPE = “string”/>
<CIMATTRIBUTE NAME = “InstallDate” TYPE = “date”/>
<CIMATTRIBUTE NAME = “NameFormat” TYEP = “string”/>
<CIMATTRIBUTE NAME '2 “OtherTypeDescription” TYPE =
“string”/>

<CIMATTRIBUTE NAME '2 “PortNumber” TYPE '2 “r8”/>
<CIMATTRIBUTE NAME '2 “ProtocolType” TYPE =

“string”/>

CIMATTRIBUTE NAME = “Status” TYE = “string”/>
</ATTRIBUTES>
</CLASS>
<CLASS NAME = “CIM_SwitchProtStatistics” ISA

“CIMCLASS”>

<ATTRIBUTES>
<CIMATTRIBUTE NAME '2 “Caption” TYPE = “string”/>
<CIMATTRIBUTE NAME '2 “CreationClassName” TYPE =

“string”/>

<CIMATTRIBUTE NAME = “DelayExceededDiscards” TYPE =

“i4”/>

<CIMATTRIBUTE NAME = “Description” TYPE = “string”/>
<CIMATTRIBUTE NAME = “MutExceededDiscards” TYPE =

“i4”/>

<CIMATTRIBUTE NAME = “SAPCreationClassName” TYPE =

“string”/>

<CIMATTRIBUTE NAME '2 “SAPName” TYPE = “string”/>
<CIMATTRIBUTE NAME = “SystemCreationClassName” TYPE

= “string”/>

<CIMATTRIBUTE NAME = “SystemName” TYEP = “string”/>
</ATTRIBUTES>
</CLASS>
The description of an instance of that class,

specifically of an element of the network to be
supervised is then as follows, for example:

<CIM_SwitchProt name= “router 1”
Namespace = “\195.9.12.245\roo\CIMV2”/>

In accordance with a communications protocol between applications of the component object model/distributed component object model (COM/DCOM) type which serves in particular to define components which can be reintegrated in other applications, the objects to be supervised, once described using a scheme of the XML type, are created dynamically.

For example, it is possible to use a dynamic invocation interface of the kind that exists in particular in Java, Corba, Visual Basic, . . . . Those interfaces make it possible while executing the program on an instance of a class to recover the attributes of a sister class or to call a method of a sister class.

In the practical implementation that has been implemented, a generic object was created serving equally well to describe classes and instances of said classes and which redefines the dynamic invocation interfaces.

That generic object presents the advantage of making it possible to use a single object to describe the supervised objects. It also makes it possible to access objects under an office application or a script language such as the following, for example: Excel, Word, Access, Visual Basic, or Wsh (Windows Shell), using the following syntax:

CompanyRouter2.Description=“this is the first router of the company”

The method of the invention can be used both for supervising a transport network and for controlling it in the “provisioning” sense. Thus, the data description can be used to configure elements of the supervised telecommunications network directly.

Another advantage of the invention is that by using a data description, i.e. a file which is separate from the gateway itself, which gateway is interpreted directly, good separation is provided between data and processing. Changes to the telecommunications network under supervision has no impact on the supervisor system, and configuring the system is extremely simple.

Furthermore, the data description file can reuse CIM schema, thus adding transparency and making it easier for humans to write and read the file.

What is claimed is:

1/ A method of using a supervisor client to supervise and control a telecommunications transport network associated with at least one data server based on a CIM type protocol, the method consisting in connecting said supervisor client to at least one gateway having means for providing a connection between said server and said supervisor client by using a description of the data of said server on the basis of a management information base, said supervisor client being based on an OPC type protocol.

2/ A method according to claim 1, in which said description is made in the XML language.

3/ A data server based on a CIM type protocol, the server including at least one gateway suitable for providing a connection with a supervisor client based on an OPC type protocol, using a description of the data of said data server on the basis of a management information base.

4/ A data server according to claim 3, in which said description is implemented in the XML language.
